(19) United States
(12) Patent Application Publication
(10) Pub. No.: US 2004/0224181 A1
(43) Pub. Date: Nov. 11, 2004

(54) Method of making multicolored jewelry and a piece of jewelry made by the method

(76) Inventor: Teresa Galan, Flushing, NY (US)

Correspondence Address: GOTTLIEB RACKMAN & REISMAN PC, 270 MADISON AVENUE, 8TH FLOOR, NEW YORK, NY, 100160601

(21) Appl. No.: 10/431,873

(22) Filed: May 7, 2003

(51) Int. Cl. B32B 15/01

(52) U.S. Cl. 428/614; 428/672

(57) ABSTRACT

A multicolored piece of jewelry is formed by producing a core made of precious metal having a first shade or color and adding a first layer having a different shade or color. The first layer is either applied only partially to the core, or, more preferably, it is added over the whole surface of the core and then is partially removed using a known abrasion technique. Next, a second layer is deposited on the core, preferably over the second layer. The core and the two layers can be made of gold alloys of different shades, or the third layer could be highly reflective metal such as rhodium.

### RELATED APPLICATIONS

None

### BACKGROUND OF THE INVENTION

1. Field of Invention

This invention pertains to a method of making a piece of jewelry made of precious metals and having several colors and patterns. More particularly, the invention pertains to a method of making a piece of jewelry with a core and several layers formed on the core with portions of the additional layers being selectively removed to achieve a highly desirable effect.

2. Background of the Invention

Various pieces of jewelry are often made from precious metals of different colors. For example, gold jewelry can be made that has shades of yellow, white, green or rose, by mixing gold with other metals. Shades of yellow and rose gold are typically made by mixing gold with copper and/or silver. Green gold is obtained from the combination of gold, silver copper and zinc. Shades of white gold are made by mixing gold with nickel, zinc, silver or platinum. These alloys may have a grayish tinge, and therefore they may be plated with rhodium which is very bright and highly reflective. However, after a while, rhodium may wear off leaving the grayish, and by comparison, unsightly white gold underneath. Rhodium is expensive and difficult to manipulate because it is very hard. Thus, it is normally used to plate other alloys.

While techniques exist for making jewelry of any one of these gold shades, it is more difficult to make a single piece of jewelry with two or more shades. One method frequently used to obtain this effect is to make thin strands of different gold shades and then to intermingle the strands to form a chain, using a weaving or braiding technique. This technique is disclosed in detail in U.S. Pat. Nos. 6,209,306; 6,481,196 and PCT/US00/09202 by Chin at al. Of course, this technique is not suitable for making solid pieces.

Another technique for making multicolored jewelry pieces involves forming several components of different color, for example by casting, and then soldering or gluing the components together. This process is time consuming and labor intensive and can be used to make only pieces having very limited shapes. U.S. Pat. No. 3,731,726 discloses a method of casing bimetallic jewelry.

### OBJECTIVES AND SUMMARY OF THE INVENTION

In view of the above, it is an objective of the present invention to provide a method of making multicolored solid jewelry pieces.

A further objective is to provide a method of making multicolored jewelry pieces that is simple and inexpensive.

A further objective is to provide a method of making multicolored jewelry pieces that can be used to generate pieces of various sizes and shapes and having various patterns.

Other objectives and advantages of the invention will become apparent from the following description.

Briefly, a method of making a multicolored jewelry piece includes forming or providing a core made of a metal having a first shade. This core is preferably made of a precious metal, such as gold having a particular shade and color. The core can be cast or otherwise formed so that it not only has a predetermined shape and size which will be essentially the shape and size of the final piece but also is decorated with an esthetically pleasing pattern, if so desired. The core can be formed with the pattern on it or the pattern can be added later.

Next, the core is plated with a first layer having a second shade or color. The second layer can be used to cover the whole core or only a portion of the core. Once the first layer is formed on the core, portions of the first layer can be removed to expose the core underneath with its first shade and pattern. This step can be performed by using any well known process and tools, including abrasion, rubbing, satins, polishing, diamond cutting, etc. The core and the first layer can be selected from rose, yellow, green or white gold, and a different color or shade being chosen for the core and the first layer. Preferably the core is rose gold.

Finally, a second layer is deposited thereon, said second layer having its own shade or color. Preferably, the second layer is disposed only on some portions on top of the first layer. This is particularly advantageous where incompatibility between the material of the core and the second layer makes depositing of the second layer on the core difficult. The second layer may be made from one of the gold alloys listed above, or may be rhodium.

### BRIEF DESCRIPTION OF THE DRAWINGS

FIG. 1 shows a flow chart for making a piece of jewelry in accordance with this invention;

FIG. 2 shows a side view of a core of a piece of jewelry in accordance with this invention;

FIG. 3 shows a partial side view of the core of FIG. 2 with a plurality of patterns;

FIG. 4 shows the core of FIG. 3 covered with a first layer with portions of the first layer being removed; and

FIG. 5 shows the core of FIG. 4 with a second layer covering some of the remaining portions of the first layer

### DETAILED DESCRIPTION OF THE INVENTION

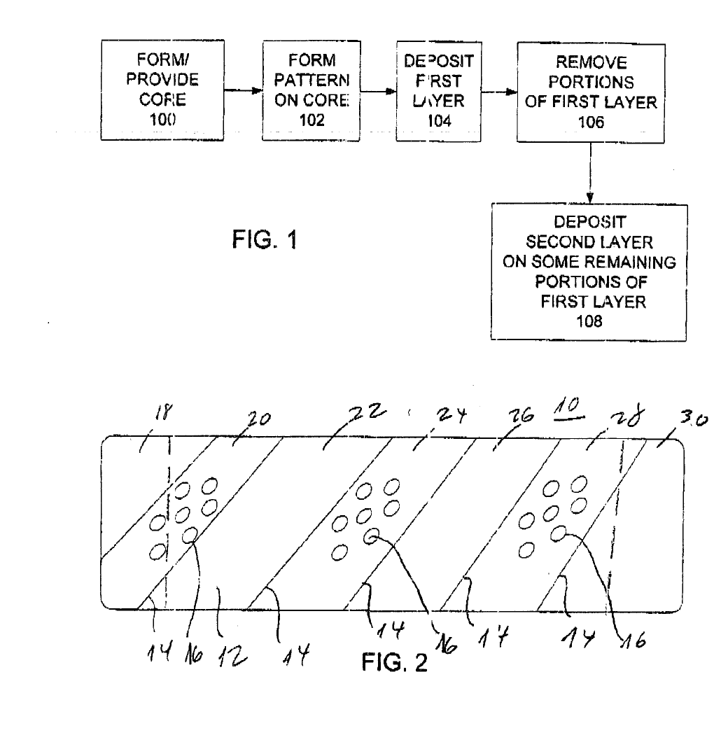

A piece of multicolored jewelry is made in accordance with this invention as follows. As shown in FIG. 1, step 100, first, a core is made from a precious metal having a specific color. For example, a core is made of rose gold, using casting or any other well known technique. FIG. 2 shows a partial side view of the core 10. The core 10 may be for a bracelet in which case the core has a toroidal shape.

The outer surface 12 of the core 10 can be smooth or can be formed with a plurality of patterns selected to give the piece an esthetically pleasing look. The design can be made in the outer surface 12 as part of making the core, or can be added later (step 102), using well-known techniques, such as abrasion or using a diamond cutting wheel. The pattern can extend over the entire surface 12, or only a part of surface 12 may be covered with the pattern. The core 10 in FIG. 2 is decorated with a pattern that includes oblique lines 14, and dots 16. The lines can be V-shaped, U-shaped, or can have any other type of shaped cross-section. The dots 16 may be grouped to form a design.

The oblique lines 14 define several peripheral zones 18, 20, 22, 24, 26, 28, 30. It should be understood that the size and shape of core 10 and the specific pattern of lines, dots and peripheral zones are described herein in for the sake of clarity and do not form a part of this invention.

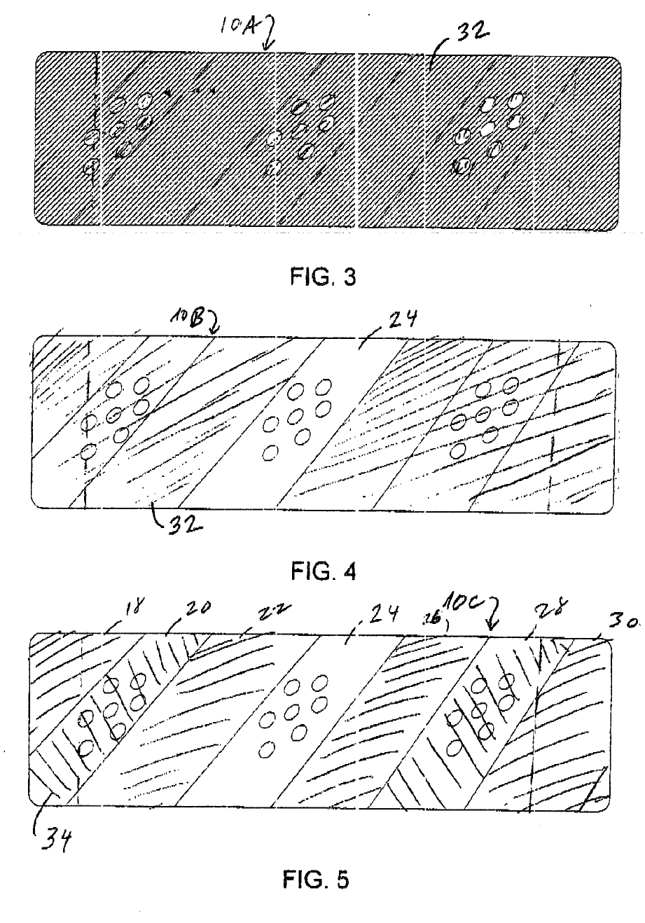

Next, in step 104, the core 10 is covered with a first layer 32 of a metal having a different shade or color to obtain a plated core 10A, as shown in FIG. 3. For example, the first layer may be a layer of yellow gold with a thickness in the range of about 1 micron, and it may be deposited by electroplating or other well known techniques.

Next, in step 106, portions of the yellow gold layer 32 from the plated core are removed, leaving the rose gold underneath. For example, as shown in FIG. 3, the yellow gold layer 32 is removed from zone 24 of a piece 10B. This step is performed using any well known techniques, such as abrasion, polishing, satin, sand blasting, etc. The same result may be obtained by depositing the yellow gold only partially on the core 10 and leaving certain portions thereof bare. However, in general, it is easier to plate the whole core with the first layer and then to remove portions of the first layer, as described above.

Next, another color is added in step 108, by depositing on certain portions of the bicolor piece 10B of FIG. 4 a second layer of, for example, rhodium, to obtain a tricolor piece 10C, shown in FIG. 5. This second layer 34 may be about 1 micron thick and can be deposited using any well known technique, such as electroplating. It should be noted that this particular combination is are particularly advantageous because it is difficult to electroplate rhodium directly on rose gold. While second layer 34 can be deposited on any part of bicolor piece 10B, in FIG. 5 the second layer 34 is shown as being deposited on zones 20 and 28. Thus, piece 10C has three portions of different shades or colors: a first portion (e.g., zone 24) which is rose gold, a second portion (e.g., zones 18, 22, 26 and 30) that is yellow gold and a third portion (e.g., zones 20 and 28) that is highly reflective from the rhodium.

Additional layers of different colors may be added as well using the principles set forth above.

Of course, many other combinations may be used as well to form multicolor pieces. In each combination, a core is made, having a rose, yellow, green or white gold shade and a first layer is selected from the same group but different shade. Additional layers may also be deposited made from a gold alloy, rhodium, or other precious and semiprecious materials.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A method of making a multicolored jewelry comprising:
providing a core made of a first metal of a first color;
plating said core with a second metal of a second color in a first layer;
removing partially said first layer to form a piece having said first color where said first layer was removed leaving in place said first layer of said second color; and
plating a second layer on portions of said layer, said second layer having a third color.

2. The method of claim 1 wherein said core is made of a gold alloy having one of a rose, white, green or yellow shade.

3. The method of claim 1 wherein said first layer is made of a gold alloy having one of a rose, white, green or yellow shade.

4. The method of claim 1 wherein said second layer is a gold alloy.

5. The method of claim 1 wherein said second layer is rhodium.

6. The method of claim 1 wherein said core is provided with a design pattern formed thereon.

7. The method of claim 1 wherein said core is provided with a plurality of lines extending at least partially circumferentially about said core.

8. The method of claim 1 further comprising forming a design pattern on said core prior to the plating of said first layer.

9. A method of making a multicolored jewelry comprising:
forming a core of a precious metal having a rose gold shade;
forming on said core a first layer having a first layer shade different then the color of said core;
partially removing said first layer from said core; and
partially plating some portions of said first layer with a second layer having a second layer shade different then said rose shade and said second layer shade;
wherein said core and layers define three sets of zones, each zone having a different shade.

10. The method of claim 9 further comprising forming said core with a pattern on its surface.

11. The method of claim 9 wherein said first and second layer shades are selected from the group consisting of white gold, yellow gold and green gold.

12. The method of claim 9 wherein said first layer shade is a white gold shade.

13. The method of claim 9 wherein said first layer shade is a yellow gold shade.

14. The method of claim 9 wherein said second layer shade is a white gold shade.

15. The method of claim 14 wherein said second layer is made of rhodium.

16. A jewelry piece comprising:
a core made of a first precious metal having a first color;
a first layer plated on said core and having a second color, said first layer covering only portions of said core; and
a second layer plated on said core and said first layer and having a third color, said first and second layers defining first, second and third sets of zones on said core, each set of zones having a different color.

17. The piece of claim 16 wherein said core is made of rose gold.

18. The piece of claim 16 wherein said first layer is selected from the group consisting of yellow and green gold.

19. The piece of claim 18 wherein said second layer is rhodium.

20. The piece of claim 16 wherein said core is formed with a pattern, said pattern being visible on each set of zones.
